(19) United States
(12) Patent Application Publication
(10) Pub. No.: US 2007/0056522 A1
(43) Pub. Date: Mar. 15, 2007

(54) Litter cleaning device

(76) Inventor: Walter Clementi, Pomona, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/227,728

(22) Filed: Sep. 14, 2005

(51) Int. Cl. A01K 29/00

(52) U.S. Cl. 119/166

(57) ABSTRACT

The invention herein described is a device and method for the cleanup and reuse of cat litter of the clumping kind. The device incorporates a screen atop a plastic box or bin. The used cat litter is poured onto the screen. Used litter remains on the screen, while unused litter passes through the screen and into the box. The used litter is dumped, and the unused litter is recycled for reuse as fresh cat litter. The box is easily cleaned, and is equipped with a tight fitting lid to cut down on orders.

### BACKGROUND OF THE INVENTION

1. Field of the Invention

This invention relates generally to the field of animal odor and waste control. More specifically, this invention is directed to a system, device, and method for facilitating the efficient and non-wasteful cleanup of litter from a cat litter box, and the efficient recycling of the unused litter therefrom.

2. Description of the Related Art

The invention of clumping cat litter has led to a revolution in keeping cats and their surroundings clean. The significant improvement in this type of litter is that it clumps together when it comes in contact with moisture, as found in cat urine and waste. The litter thus has an indicating feature, and cat owners know that when the cat litter is filled with lumps, it is time to change the litter.

Despite the advancements in cat litter, current techniques for removing the waste and urine from the litter have proven ineffective. Due to the brittle nature of the litter clumps, removal can cause the clumps to break and re-contaminate the unused litter. In addressing this problem, prior art has developed a number of cat litter screens in an attempt to effectively remove cat litter and prevent re-contamination.

One such prior art displays a cat litter screening device with two bottom screen panels, hinged together. It is designed to sit on the floor of a litter box, with the cat litter above it. It has high handles for pulling the screen up, and thereby screening out the free litter and retaining the used clumps of litter and refuse.

A second device reveals a cat litter sifter screen. As a design patent, it does not reveal full details of the invention, nor a method for its use.

A third device describes a cat litter screening device which has two pans facing one another, an upper and a lower pan, with a screen in between. The pans can be inverted to force the screen to separate the litter.

A fourth device has a cutaway insert with a screen at the bottom. It is designed to sit on the floor of the litter box, and be pulled up thru the litter when changing, thus screening the clumps out of the litter.

The prior art inventions have not provided sufficient means to remedy the problems associated with the removal of cat litter. A problem common to all previous devices and methods is that they involve a high degree of force to separate the clumped litter from the clean, free-flowing litter. Due to the excessive force that is applied during the removal process, the fragile clumps of used litter disintegrate into smaller pieces resulting in re-contamination of the unused litter with waste. The present invention improves on the separation process by providing a filtration device that lessens the impact and all but eliminates the breaking of the litter clumps. This allows the litter to stay fresh, it eliminates odor and extends the lifetime of the product.

In addition to the contamination problem, prior art devices are also more difficult to use. Due to the cumbersome features of the prior art, the separation process generally results in a considerable mess. The present invention eliminates such difficulties and provides an easy and efficient way of disposing of the used litter. Furthermore, the present invention lowers the costs associated with the purchase of new litter since it extends the lifetime of the product.

There is thus a need in the industry for a simple, efficient device and method for the separation of waste material and used litter from free-flowing, reusable litter.

### SUMMARY OF THE INVENTION

The invention herein described is a device and method for the cleanup and reuse of cat litter of the clumping kind. The device incorporates a screen atop a plastic box or bin. The used cat litter is poured onto the screen. Used litter remains on the screen, while unused litter passes through the screen and into the box. The used litter is dumped, and the unused litter is recycled for reuse as fresh cat litter. The box is easily cleaned, and is equipped with a tight fitting lid to cut down on orders.

The primary object of the invention is to provide easy separation of used and waste litter and associated waste from unused and reusable free-flowing litter.

Another object of the invention is to provide a controlled separation of used and waste litter.

Another object of the invention is to allow for the recycle of unused litter.

Another object of the invention is to provide a method of odor control from cat litter.

Another object of the invention is to provide a method for the use of the present invention to clean up and recycle cat litter.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded view of the present invention with lid, screen, rails, and rail caps in unassembled view.

FIG. 2 is a view of the assembled screen and box, with used litter from a litter box being poured onto the top of the screen.

FIG. 3 is perspective view of an embodiment of the present invention, after receiving used litter.

FIG. 4 is a view of the interior of the present invention, as the screen is being removed.

FIG. 5 portrays the present invention in closed configuration, with the tight fitting lid in place.

FIG. 6 is a cutaway side view of the present invention, after litter from a litter box has been poured onto the top of the screen.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

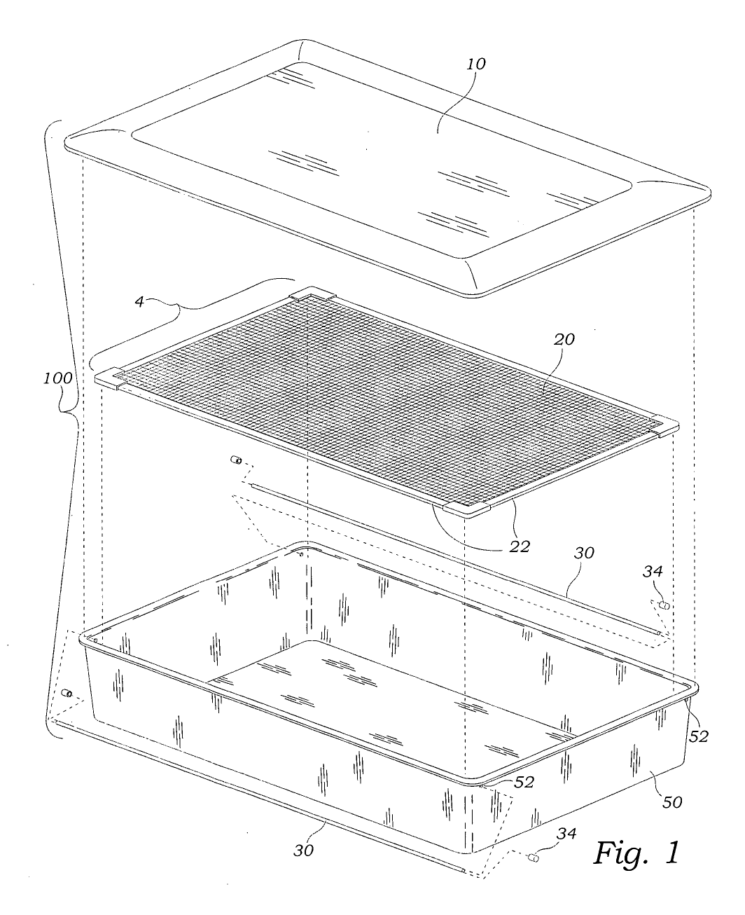

FIG. 1 depicts the components of the invention in a disassembled, exploded view. The basic structure of the invention is a collection box 50. This box is preferably comprised of plastic, for purposes of being airtight when sealed at the top. This feature will prevent any odors from emitting from the box during periods of inactivity and storage.

Just above and below collection box 50 are found the two support rails 30. These rails are designed to fit snugly through apertures 52, found at the upper right and left of each end of the box. When in place, the rails are capped with end caps 34. The end caps fit snugly, and have a larger circumference than can fit through apertures 52. Thus, the rails are held in place until the end caps 34 are removed by the operator, as during a cleaning of the system.

During manufacture, apertures 52 are produced by drilling holes of the proper size it the correct locations on the box 50. The support rails 30 are preferably 0.25 inch rods, made of steel or other hard metal, while the end caps 34 are preferably made of soft plastic, and just large enough to fit over the ends of the rails. The support rails 30 must be long enough to extend past both ends of the box 50, at least far enough to accommodate end caps 34.

The support rails 30 are used to support screen 20. Screen 20 is preferably dimensioned slightly smaller on all sides than the edges of collection box 50. This allows spillage off the sides of the screen to end up in the box, rather than on the floor. However, the clearance cannot be too large, or clumps will fall through and not be separated from the recyclable unused litter 76. An ideal spacing is 1 cm all around.

Screen 20 is given strength and structure from its surrounding frame 22. The corners of this frame are protected by corner guards 24. This protects the box walls from being gouged or nicked by the screen frame.

Ideally, the screen frame 22 is comprised of lightweight metal, screen 20 itself is comprised of wire mesh, and the corner guards 24 are made of plastic.

Finally, at the top is found lid 10. This lid 10 is not designed for use during operation, but rather is placed on the top of collection box 50 after use, and during storage. This tight-fitting lid helps to keep odors within the box from escaping into the surrounding environment. This lid 10 is preferably made of the same material as box 50, or at least of compatible material, and dimensioned to provide a tight fit.

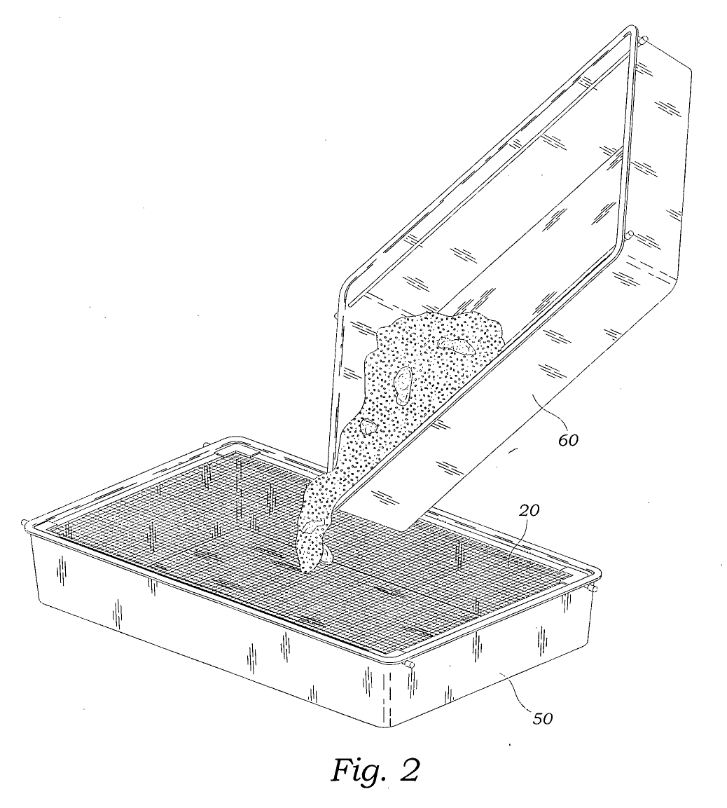

Now moving to FIG. 2, used litter 76 containing waste 72 clumps is dumped onto the screen 20, in place on top of box 50. Container 60 is depicted as being identical to box 50, but need not be so. In fact, container 60 can be any container suitable for transporting used litter 76. Litter can even be dumped onto the screen of the current invention directly from a litter box, provided said litter box is portable.

It is important in this operation that the litter 76 be spread over a wide area of screen 20, but at the same time, the litter 76 should not be subjected to force. The principle in operation is that of gravity, which provides sufficient force to allow the free-flowing litter 76 to fall through the mesh apertures, while retaining the clumps of waste 72 material and used litter 76.

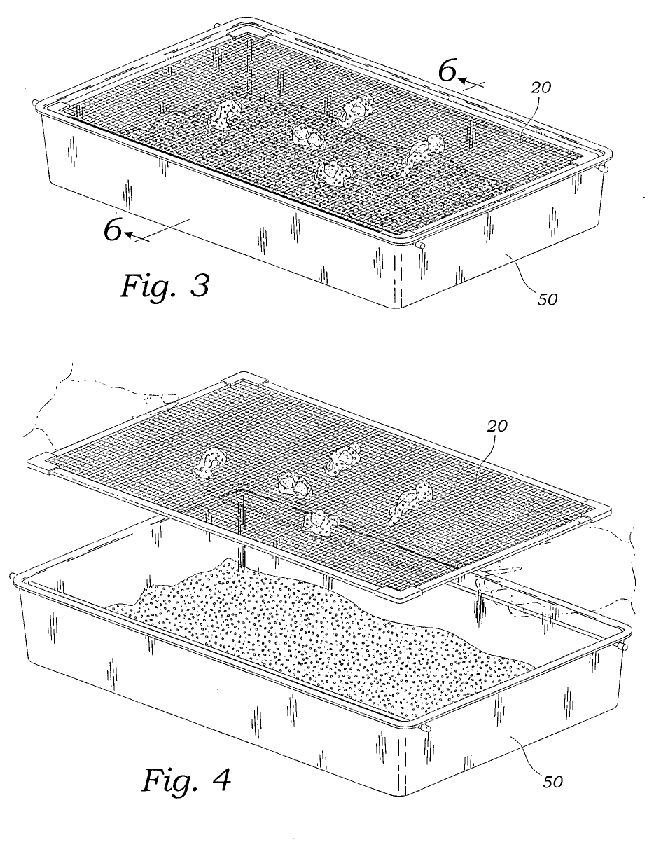

In FIG. 3, after spreading over a wide area of screen 20, the waste 72 will collect on the top of the screen 20. The used litter 76 will be separated from the waste 72 and settle into the collection box 50. Such separation is evident from the view provided in FIG. 6.

In FIG. 4, after the litter 76 has settled into the collection box 50, the screen 20 must then be lifted from the collection box 50. It is important that the screen 20 be removed from the collection box 50 very carefully as to avoid the waste 72 breaking apart and re-contaminating the used litter 76. Similarly, while carrying the waste 72 to a disposal site, special care must be taken to avoid excessive force, which would result in the breaking of the waste 72 and cause a mess in the immediate vicinity.

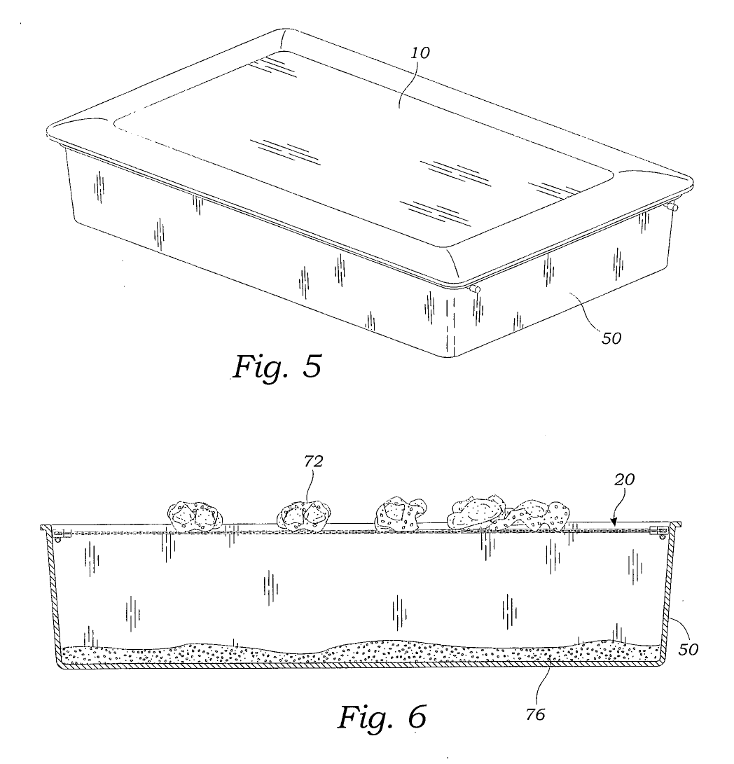

In FIG. 5, following disposal of the waste 72, the litter 76 that has collected at the bottom of the collection box 50 is to be replaced into the litter box. The screen 20 is to be placed back onto the support rails 30 in the collection box 50. In order to keep odors from spreading to the surrounding environment, a lid 10 is placed over the collection box 50. The lid 10 is specially fitted in order to securely fit onto the collection box 50. In the alternative, both the collection box 50 and the screen 20 may be cleaned following their use.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A device for the cleaning and recycling of used cat litter, comprising:
An open-top box with four vertical walls and a floor;
A flat screen, between approximately 0.5 and 10 centimeters shorter in its length than the length of said box, and between approximately 0.5 and 10 centimeters shorter in its width than the width of said box; and,
Support means at or near the top of the box to support said screen in a horizontal position at or near the top of the box.

2. The device of claim 1, wherein said screen is composed of wire mesh.

3. The device of claim 1, further comprising protective corner guards at each corner of said screen.

4. The device of claim 1, wherein said support means comprise a pair of rails.

5. The device of claim 4, further comprising protective end caps at the ends of said rails.

6. The device of claim 4, wherein said rails are supported in horizontal configuration at the top of said box.

7. The device of claim 4, further comprising apertures at both ends of said box to support said rails.

8. The device of claim 1, wherein said box is composed of plastic.

9. The device of claim 1, further comprising tight-fitting lid to cover said open top of said box.

10. The device of claim 4, wherein said rails are comprised of cylindrical shafts of metal.

11. A device for the cleaning and recycling of used cat litter, comprising:
an open-top box with four vertical walls and a floor;
a flat wire mesh screen, between approximately 1 and 10 centimeters shorter in its length than the length of said box, and between approximately 1 and 10 centimeters shorter in its width than the width of said box;
a pair of metal rails at or near the top of the box to support said screen in a horizontal position at or near the top of the box; and,
a tight-fitting lid to cover the box.

12. A method for the cleaning and recycling of cat litter, using the device of claim 1, said method comprising the steps of:
Assembling the device with the screen supported atop the box;
Spreading used cat litter atop the screen, taking care not to shake the device;
Allowing the free-flowing litter to fall through the screen into the box;
Disposing of the used litter remaining on top of the screen;
Returning the litter in the box to reuse as cat litter; and
Closing the box with the lid to control odors.
